(19) United States
(12) Patent Application Publication
(10) Pub. No.: US 2019/0250959 A1
(43) Pub. Date: Aug. 15, 2019

(54) COMPUTING RESOURCE BALANCING AMONG DIFFERENT COMPUTING ZONES

(71) Applicant: Red Hat, Inc., Raleigh, NC (US)

(72) Inventor: Huamin Chen, Westford, MA (US)

(21) Appl. No.: 15/896,567

(22) Filed: Feb. 14, 2018

(51) Int. Cl. G06F 9/50; H04L 12/26; H04L 12/24; H04L 12/911

(52) U.S. Cl. CPC G06F 9/5077; H04L 43/0876; G06F 9/5072; H04L 47/783; H04L 41/042

(57) ABSTRACT

Computing resource balancing among different computing zones is provided. A processor device receives first metric information that quantifies resource utilization in a first computing zone comprising one or more first zone computing resources. The processor device receives second metric information that quantifies resource utilization in a second computing zone comprising one or more second zone computing resources. Based on a relationship between the first metric information and the second metric information, the processor device sends a control signal to terminate or initiate a first zone computing resource or a second zone computing resource.

### TECHNICAL FIELD

The examples relate generally to controlling computing resources, and in particular to computing resource balancing among different computing zones.

### BACKGROUND

Increasingly, companies provide computing services to users from multiple different data centers for purposes of, for example, redundancy and/or geographic proximity to certain users. For example, a company may provide computing services from a cloud service provider that has a data center geographically located on a west coast to service users from a western portion of a country and a cloud service provider that has a data center geographically located on an east coast to service users from an eastern portion of the country.

### SUMMARY

The examples disclosed herein implement computing resource balancing among different computing zones. The examples evaluate resource utilization of computing resources in a first computing zone and resource utilization of computing resources in a second computing zone to determine if the resource utilizations are within a predetermined balance threshold of one another. If not, the examples may terminate one or more computing resources of one computing zone and/or initiate one or more computing resources in another computing zone to bring the resource utilizations of the first and second computing zones within the predetermined balance threshold of one another. Among other advantages, the examples help optimize the number of computing resources in the different computing zones.

In one example a method is provided. The method includes receiving, by a computing device comprising a processor device, first metric information that quantifies resource utilization in a first computing zone comprising one or more first zone computing resources. The method further includes receiving second metric information that quantifies resource utilization in a second computing zone comprising one or more second zone computing resources. The method further includes, based on a relationship between the first metric information and the second metric information, sending a control signal to terminate or initiate a first zone computing resource or a second zone computing resource.

In another example a computing device is provided. The computing device includes a memory and a processor device coupled to the memory. The processor device is to receive first metric information that quantifies resource utilization in a first computing zone comprising one or more first zone computing resources. The processor device is further to receive second metric information that quantifies resource utilization in a second computing zone comprising one or more second zone computing resources. The processor device is further to, based on a relationship between the first metric information and the second metric information, send a control signal to terminate or initiate a first zone computing resource or a second zone computing resource.

In another example a computer program product is provided. The computer program product is stored on a non-transitory computer-readable storage medium and includes instructions to cause a processor device to receive first metric information that quantifies resource utilization in a first computing zone comprising one or more first zone computing resources. The instructions further cause the processor device to receive second metric information that quantifies resource utilization in a second computing zone comprising one or more second zone computing resources. The instructions further cause the processor device to, based on a relationship between the first metric information and the second metric information, send a control signal to terminate or initiate a first zone computing resource or a second zone computing resource.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIGS. 1A-1E illustrate an example environment in which examples encompassed herein may be practiced;

FIG. 2 is a flowchart of a method for implementing computing resource balancing among different computing zones according to one example;

FIG. 3 is a simplified block diagram of the environment illustrated in FIGS. 1A and 1B according to another example; and

FIG. 4 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first computing zone” and “second computing zone,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified.

Increasingly, companies provide computing services to users from multiple different data centers for purposes of, for example, redundancy and/or geographic proximity to certain users. For example, a company may utilize a cloud service provider to provide computing services from a data center geographically located on a west coast to service users of the company that reside in a western portion of a country, and may utilize the same or a different cloud service provider to provide computing services from a data center geographically located on an east coast to service users of the company that reside in an eastern portion of the country. Using cloud services from geographically different locations is sometimes referred to as cloud federation.

While each data center may have its own resource monitoring mechanism to ensure sufficient computing resources are initiated in accordance with certain predetermined resource utilization criteria, each data center conventionally monitors resources independent of services provided via other data centers. One result of this is that the overall number of computing resources in multiple data centers may be in excess of what is needed to provide suitable services to users. This leads to inefficiencies since computing resources, such as computing hosts, virtual machines, or containers that are dedicated to providing a service but are underutilized still utilize finite resources, such as processor devices and memory, that cannot be utilized by other computing resources. Moreover, inefficiencies can increase costs where computing resources are paid for on a metered basis, as is often the case in a cloud computing environment.

The examples disclosed herein implement computing resource balancing among different computing zones. The examples evaluate resource utilization of computing resources in a first computing zone and resource utilization of computing resources in a second computing zone to determine if the resource utilizations are within a predetermined balance threshold of one another. If not, the examples may terminate one or more computing resources of one computing zone and/or initiate one or more computing resources in another computing zone to bring the resource utilizations of the first and second computing zones within the predetermined balance threshold of one another. Among other advantages, the examples help optimize the number of computing resources in the computing zones.

In one example an improved resource controller computing device that operates across multiple computing zones is provided. The resource controller computing device not only monitors metric information that quantifies resource utilization, but monitors metric information that quantifies resource utilization from multiple zones, and then generates control signals based on relationships of the resource utilization of both zones to bring the zones within a predetermined balance threshold. Among other advantages, the improved resource controller computing device helps ensure that computing resources in multiple zones are utilized as efficiently as possible. The efficient utilization of resources reduces costs, and enables finite computing resources to be allocated efficiently across a number of applications all competing for the finite computing resources.

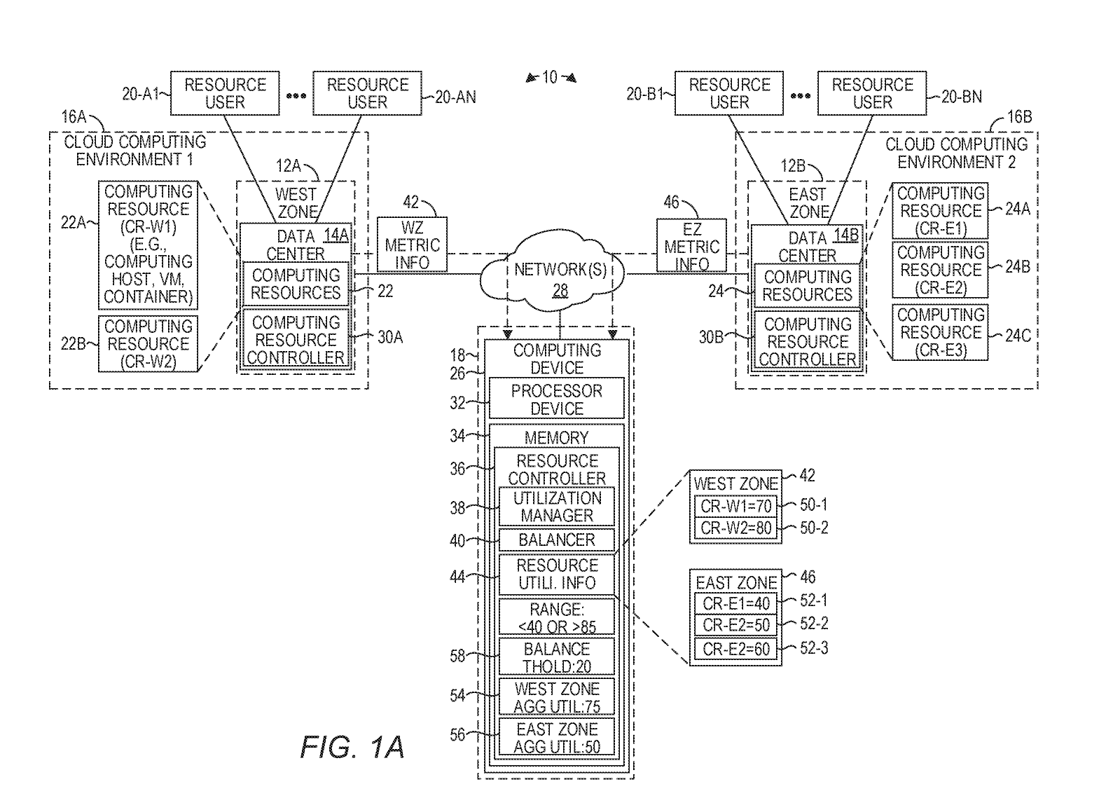

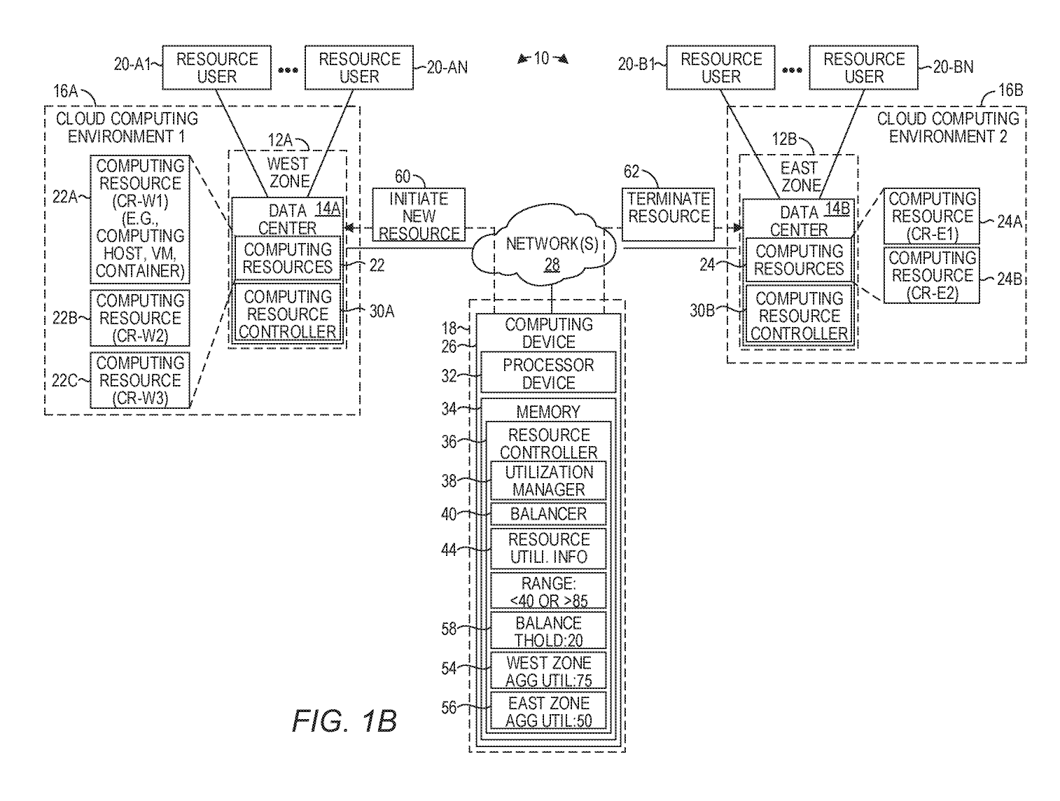

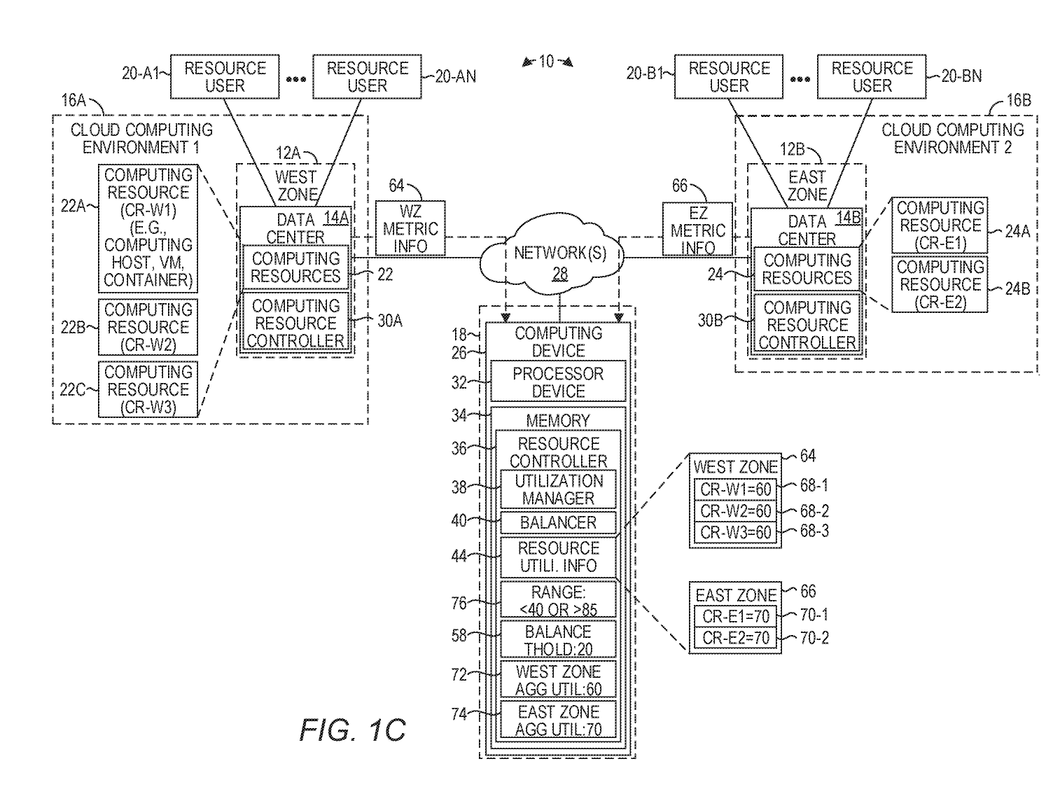

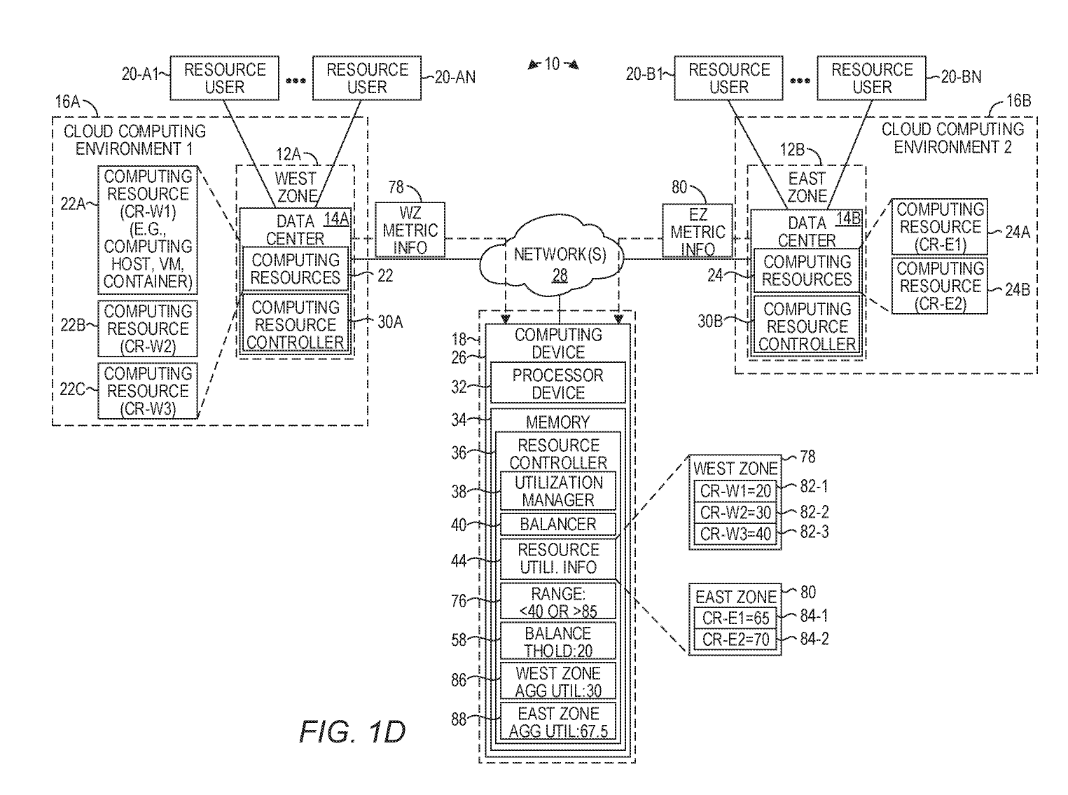

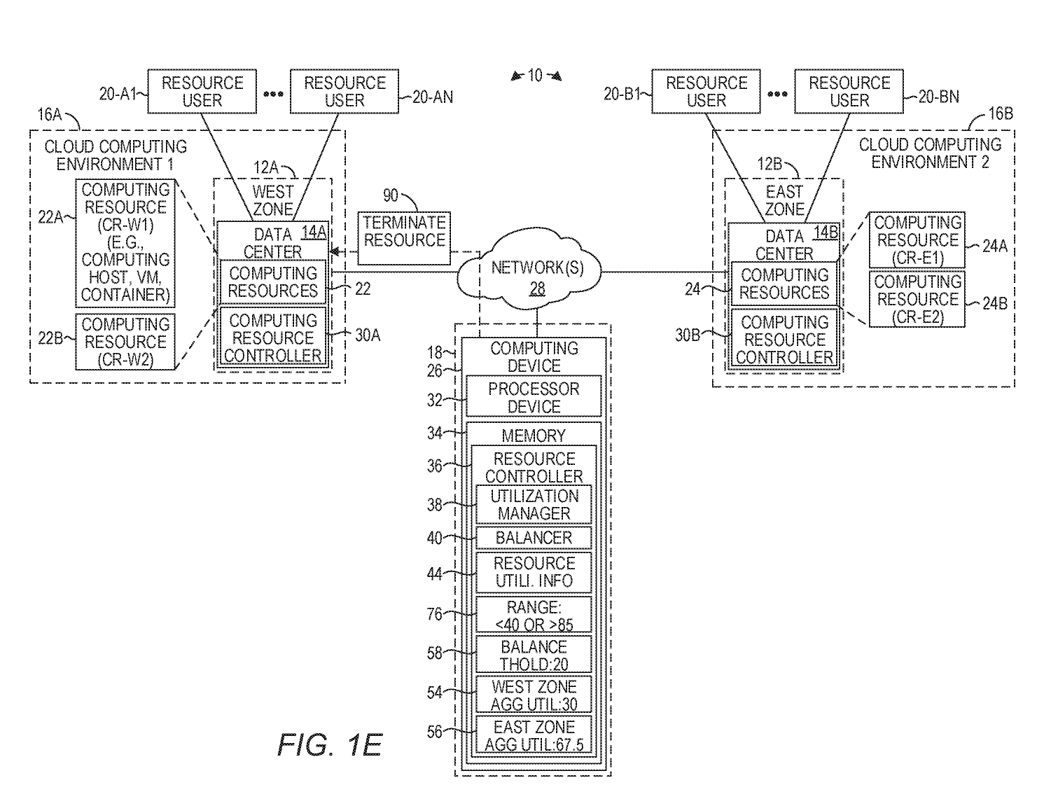

FIGS. 1A-1E illustrate an example environment 10 in which examples encompassed herein may be practiced. Referring first to FIG. 1A, the environment 10 includes a first computing zone 12A (“WEST ZONE”) and a second computing zone 12B (“EAST ZONE”). The first computing zone 12A includes a first data center 14A and the second computing zone 12B includes a second data center 14B. In some examples, the first computing zone 12A and the second computing zone 12B may be geographically located in different time zones, such as the pacific time zone and the eastern time zone, respectively.

The phrase “data center” as used herein, such as the first data center 14A and the second data center 14B, refers to a plurality of host computing devices housed together in a physical location, such as in a building. The host computing devices may be configured to implement additional computing resources, such as virtual machines, containers, or the like, upon request. The host computing devices in a data center may be communicatively coupled to one another via a local area network (LAN) technology. The first data center 14A and the second data center 14B are separate physical structures at geographically different locations, and may be located hundreds or thousands of miles from one another.

In some examples, the first computing zone 12A may implement a cloud computing environment 16A that can be used by a number of different third-party entities, such as an entity 18 to provide services to a plurality of resource users 20-A1-20-AN. In a retail context, for example, the entity 18 may be a retail business, and the resource users 20-A1-20-AN may be consumers. The retail business (e.g., entity 18) may implement a website in the cloud computing environment 16A that allows the consumers (e.g., resource users 20-A1-20-AN) to purchase products from the retail business. As another example, in the context of a research organization, the entity 18 may be a non-profit entity, and the resource users 20-A1-20-AN may be scientists. The non-profit entity (e.g., entity 18) may provide research services to the scientists (e.g., resource users 20-A1-20-AN) via the cloud computing environment 16A.

For purposes of redundancy, scale, geography, cloud provider limitations, or other reasons, the entity 18 may also provide services to a plurality of resource users 20-B1-20-BN via the second computing zone 12B. In some examples, the second computing zone 12B may implement a cloud computing environment 16B in a manner similar to that discussed above with regard to the cloud computing environment 16A. In some examples, the cloud computing environment 16A may be provided by a first cloud provider, and the cloud computing environment 16B may be provided by a second, different cloud provider. In some examples, the cloud computing environment 16A and the cloud computing environment 16B may be provided by the same cloud provider. The use of multiple cloud computing environments to provide a same service is sometimes referred to as cloud federation.

It should be noted that in some examples the cloud computing environment 16A is completely unaware of the cloud computing environment 16B, and things occurring in the cloud computing environment 16A are occurring independently of things occurring in the cloud computing environment 16B.

The cloud computing environment 16A provides services to the entity 18 via a plurality of computing resources 22. The cloud computing environment 16A may be able to initiate upon request or demand from the entity 18 or other third-party entities hundreds, thousands, or even millions of computing resources 22 upon request. The computing resources 22 may comprise, for example, a host computing device, or a virtual machine executing on a host computing device, or a container process, such as a Docker® container, executing on a host computing device. The computing resources 22 may be initiated and/or terminated automatically by the cloud computing environment 16A, such as in response to certain criteria, or via request from the entity 18 or other third-party entity.

Similarly, the cloud computing environment 16B provides services to the entity 18 via a plurality of computing resources 24. The cloud computing environment 16B may be able to initiate upon request or demand from the entity 18 or other third-party entities hundreds, thousands, or even millions of computing resources 24 upon request. The computing resources 24 may comprise, for example, a host computing device, or a virtual machine executing on a host computing device, or a container process, such as a Docker® container, executing on a host computing device. The computing resources 24 may be initiated and or terminated automatically by the cloud computing environment 16B, such as in response to certain criteria, or via request from the entity 18 or other third party entity.

The entity 18 includes a computing device 26 which is configured to communicate with the cloud computing environments 16A, 16B via one or more networks 28. In particular, the data center 14A may include a computing resource controller 30A that is configured to communicate with the computing device 26. The communications may take place, for example, via an application programming interface (API), via the sending of messages between the computing resource controller 30A and the computing device 26, or via any other mechanism for communicating between two computing devices via a network. In particular, the data center 14B may similarly include a computing resource controller 30B that is configured to communicate with the computing device 26. The communications between the computing device 26 and the computing resource controller 30B may take place in the same manner as those between the computing device 26 and the computing resource controller 30A, or via a different manner.

The data center 14A may also be able to provide metric information about computing resources 22 used by the entity 18 upon request from the computing device 26. The metric information may include any suitable resource utilization information, such as, by way of non-limiting example, processor utilization of a computing resource 22, memory utilization of a computing resource 22, network utilization of a computing resource 22, disk usage utilization of a computing resource 22, or the like. Similarly, the data center 14B is also configured to provide metric information about computing resources 24 used by the entity 18 upon request from the computing device 26.

The computing device 26 includes a processor device 32 coupled to a memory 34. In one example, the memory 34 includes a resource controller 36 that manages the computing resources 22, 24 in the data centers 14A, 14B, respectively, in a manner that facilitates resource balancing among the first computing zone 12A and the second computing zone 12B. It will be noted that because the resource controller 36 is a component of the computing device 26, functionality implemented by the resource controller 36 may be attributed herein to the computing device 26 generally. Moreover, in examples such as shown in FIG. 1A where the resource controller 36 comprises software instructions that program the processor device 32 to carry out functionality discussed herein, functionality implemented by the resource controller 36 may be attributed herein to the processor device 32.

The resource controller 36 is illustrated as having a utilization manager 38 component and a balancer 40 component; however, it will be apparent that the novel functionality attributed herein to the resource controller 36, the processor device 32, and/or the computing device 26 could be implemented in any number of components and that the examples are not limited to a resource controller with any particular number of components.

For purposes of illustration, assume that at a time T1 the data center 14A includes a computing resource 22A and a computing resource 22B that are designated as being associated with the entity 18 and that are providing services to the resource users 20-A1-20-AN. Note that the computing resources 22 may include hundreds or thousands of other computing resources 22 that are not illustrated for purposes of clarity. At the time T1, the data center 14B includes computing resources 24A, 24B, and 24C that are designated as being associated with the entity 18 and that are providing services to the resource users 20-B1-20-BN. Again, note that the computing resources 24 may include hundreds or thousands of other computing resources 24 that are not illustrated for purposes of clarity.

Periodically or intermittently the computing device 26, via, in one example, the utilization manager 38, sends a message to the data center 14A requesting metric information that quantifies resource utilization in the first computing zone 12A of the computing resources 22A, 22B. In response, the data center 14A generates and sends metric information 42 to the computing device 26. The metric information 42 quantifies resource utilization of the computing resources 22A, 22B. As discussed above, the metric information 42 may comprise, for example, the processor utilization, memory utilization, network utilization, and/or disk utilization of the computing resources 22A, 22B at the time that the data center 14A generated the metric information 42. Solely for purposes of illustration, the examples will be discussed herein in the context of processor utilization, but it is apparent that the features disclosed herein could be applied to any metric information that quantifies resource utilization.

The computing device 26 receives the metric information 42 and may maintain the metric information 42 in a resource utilization information 44 in the memory 34. Similarly, the computing device 26, via, in one example, the utilization manager 38, sends a message to the data center 14B requesting metric information that quantifies resource utilization in the second computing zone 12B of the computing resources 24A, 24B, 24C. In response, the data center 14B generates and sends metric information 46 to the computing device 26. The metric information 46 quantifies resource utilization of the computing resources 24A-24C. The computing device 26 receives the metric information 46 and may maintain the metric information 46 in the resource utilization information 44 in the memory 34.

In this example, the metric information 42 includes a processor resource utilization value 50-1 that identifies the processor utilization of the computing resource 22A as 70%. The metric information 42 includes a processor resource utilization value 50-2 that identifies the processor utilization of the computing resource 22B as 80%. The metric information 46 includes a processor resource utilization value 52-1 that identifies the processor utilization of the computing resource 24A as 40%, a processor resource utilization value 52-2 that identifies the processor utilization of the computing resource 24B as 50%, and a processor resource utilization value 52-3 that identifies the processor utilization of the computing resource 24C as 60%.

The computing device 26, via the balancer 40 for example, determines an aggregate resource utilization value 54 (i.e., 75) associated with the first computing zone 12A based on the metric information 42. In particular, in this example, the aggregate resource utilization value 54 is an average resource utilization value and is determined by the balancer 40 based on the processor resource utilization values 50-1 and 50-2 divided by the total quantity of computing resources 22A and 22B, which in this case, is two.

The balancer 40 also determines an aggregate resource utilization value 56 (i.e., 50) associated with the second computing zone 12B based on the metric information 46. In particular, in this example, the aggregate resource utilization value 56 is an average resource utilization value and is determined by the balancer 40 based on the processor resource utilization values 52-1-52-3 divided by the total quantity of computing resources 24A-24C, which in this case, is three.

The balancer 40 determines that the difference between the aggregate resource utilization value 56 (50) and the aggregate resource utilization value 54 (75) is 25. The balancer 40 accesses a predetermined balance threshold value 58, which in this example is 20. The balance threshold value 58 may be user-configurable by the entity 18. Moreover, it will be apparent that the balance threshold value 58 may be any desired value, or range of values. For example, the balance threshold value 58 may be any value between 10 and 40. The determination by the balancer 40 that the difference 25 is greater than the predetermined balance threshold value 58, triggers a rebalancing process by the balancer 40 to change the number of computing resources 22 and/or the number of computing resources 24 to bring the aggregate resource utilizations of the computing resources 22 and the computing resources 24 within the balance threshold value 58 (i.e., 20).

The precise formula used by the balancer 40 may differ depending on desired goals and implementation. In some examples, the balancer 40 may target a desired aggregate resource utilization in each computing zone, and based on the known aggregate resource utilization values, estimate a number of computing resources that must be initiated, or terminated, in a computing zone to reach the desired aggregate resource utilization value.

Referring now to FIG. 1B, in this example, the balancer 40 determines that one computing resource 22 should be added to the first computing zone 12A and one computing resource 24 should be terminated from the second computing zone 12B. The balancer 40 generates and sends a control signal 60, in the form of a message, to the computing resource controller 30A of the first computing zone 12A to initiate an additional computing resource 22 in the first computing zone 12A. In response, the computing resource controller 30A initiates a new computing resource 22C in the first computing zone 12A to provide services to the resource users 20-A1-20-AN.

The balancer 40 generates and sends a control signal 62, in the form of a message, to the computing resource controller 30B of the second computing zone 12B to terminate a computing resource 24 in the second computing zone 12B. In some examples, the control signal 62 may identify a particular computing resource 24 to terminate. For example, the control signal 62 may identify the computing resource 24 with the lowest processor utilization or the highest processor utilization. In response, the computing resource controller 30B terminates the computing resource 24C in the second computing zone 12B. Services to the resource users 20-B1-20-BN are then provided by the computing resources 24A, 24B.

Referring now to FIG. 1C, at a point in time subsequent to that illustrated in FIG. 1B, the utilization manager 38 sends a message to the data center 14A requesting metric information that quantifies resource utilization in the first computing zone 12A of the computing resources 22A-22C, and sends a message to the data center 14B requesting metric information that quantifies resource utilization in the second computing zone 12B of the computing resources 24A-24B. In response, the data centers 14A, 14B generate and send metric information 64, 66 to the computing device 26.

The metric information 64 quantifies resource utilization of the computing resources 22A-22C. The computing device 26 receives the metric information 64 and may maintain the metric information 64 in the resource utilization information 44 in the memory 34. The metric information 66 quantifies resource utilization of the computing resources 24A, 24B.

In this example, the metric information 64 includes a processor resource utilization value 68-1 that identifies the processor utilization of the computing resource 22A as 60%, a processor resource utilization value 68-2 that identifies the processor utilization of the computing resource 22B as 60%, and a processor resource utilization value 68-3 that identifies the processor utilization of the computing resource 22C as 60%. The metric information 66 includes a processor resource utilization value 70-1 that identifies the processor utilization of the computing resource 24A as 70%, and a processor resource utilization value 70-2 that identifies the processor utilization of the computing resource 24B as 70%.

The balancer 40 determines an aggregate resource utilization value 72 (i.e., 60) associated with the first computing zone 12A based on the metric information 64. In particular, in this example, the aggregate resource utilization value 72 is an average resource utilization value and is determined by the balancer 40 based on the processor resource utilization values 68-1, 68-2, and 68-3 divided by the total quantity of computing resources 22A-22C, which in this case is three.

The balancer 40 also determines an aggregate resource utilization value 74 (i.e., 70) associated with the second computing zone 12B based on the metric information 66. In particular, in this example, the aggregate resource utilization value 74 is an average resource utilization value and is determined by the balancer 40 based on the processor resource utilization values 70-1 and 70-2 divided by the total quantity of computing resources 24A-24B, which in this case is two.

The balancer 40 determines that the difference between the aggregate resource utilization value 72 (60) and the aggregate resource utilization value 74 (70) is 10, and is now less than the predetermined balance threshold value 58, which in this example is 20. The determination by the balancer 40 that the difference 10 is less than the predetermined balance threshold value 58 results in the balancer 40 determining that no initiation or termination of computing resources in the first computing zone 12A or the second computing zone 12B will be done at this time.

The process illustrated in FIGS. 1A-1C may be performed by the computing device 26 iteratively over time to repeatedly request and receive metric information from the first computing zone 12A and the second computing zone 12B, determine a current relationship between the metric information from the first computing zone 12A and the second computing zone 12B, and based on the current relationship, 1) send a control signal to terminate or initiate a computing resource 22 in the first computing zone 12A or a computing resource 24 in the second computing zone 12B, or 2) maintain the current number of computing resources 22 and computing resources 24 by not sending a control signal that terminates or initiates computing resources 22 and/or computing resources 24.

In some examples, the balancer 40 only determines if the aggregate resource utilization associated with the first computing zone 12A is within the balance threshold value 58 of the aggregate resource utilization associated with the second computing zone 12B if either the aggregate resource utilization associated with the first computing zone 12A or the aggregate resource utilization associated with the second computing zone 12B is outside of a range 76. The range 76 may be user-configurable by the entity 18. In this example, the range 76 is less than 40 or greater than 85. Thus, in this example, the balancer 40 only determines if the aggregate resource utilization associated with the first computing zone 12A is within the balance threshold value 58 of the aggregate resource utilization associated with the second computing zone 12B if either the aggregate resource utilization associated with the first computing zone 12A or the aggregate resource utilization associated with the second computing zone 12B has an aggregate resource utilization of less than 40 or greater than 85.

Referring now to FIG. 1D, at a point in time subsequent to that illustrated in FIG. 1C, the utilization manager 38 sends a message to the data center 14A requesting metric information that quantifies resource utilization in the first computing zone 12A of the computing resources 22A-22C, and sends a message to the data center 14B requesting metric information that quantifies resource utilization in the second computing zone 12B of the computing resources 24A-24B. In response, the data centers 14A, 14B generate and send metric information 78, 80 to the computing device 26.

The computing device 26 receives the metric information 78, 80 and maintains the metric information 78, 80 in the resource utilization information 44 in the memory 34. The metric information 78 includes a processor resource utilization value 82-1 that identifies the processor utilization of the computing resource 22A as 20%, a processor resource utilization value 82-2 that identifies the processor utilization of the computing resource 22B as 30%, and a processor resource utilization value 82-3 that identifies the processor utilization of the computing resource 22C as 40%. The metric information 80 includes a processor resource utilization value 84-1 that identifies the processor utilization of the computing resource 24A as 65%, and a processor resource utilization value 84-2 that identifies the processor utilization of the computing resource 24B as 70%.

The balancer 40 determines an aggregate resource utilization value 86 (i.e., 30) associated with the first computing zone 12A based on the metric information 78. The balancer 40 also determines an aggregate resource utilization value 88 (i.e., 67.5) associated with the second computing zone 12B based on the metric information 80. The balancer 40 determines that the difference between the aggregate resource utilization value 86 (30) and the aggregate resource utilization value 88 (67.5) is 37.5, and is greater than the predetermined balance threshold value 58 (i.e., 20).

Referring now to FIG. 1E, in response to the determination that the difference between the aggregate resource utilization value 86 (30) and the aggregate resource utilization value 88 (67.5) is 37.5, and is greater than the predetermined balance threshold value 58 (i.e., 20), the balancer 40 generates and sends a control signal 90, in the form of a message, to the computing resource controller 30A of the first computing zone 12A to terminate a computing resource 22 in the second computing zone 12B.

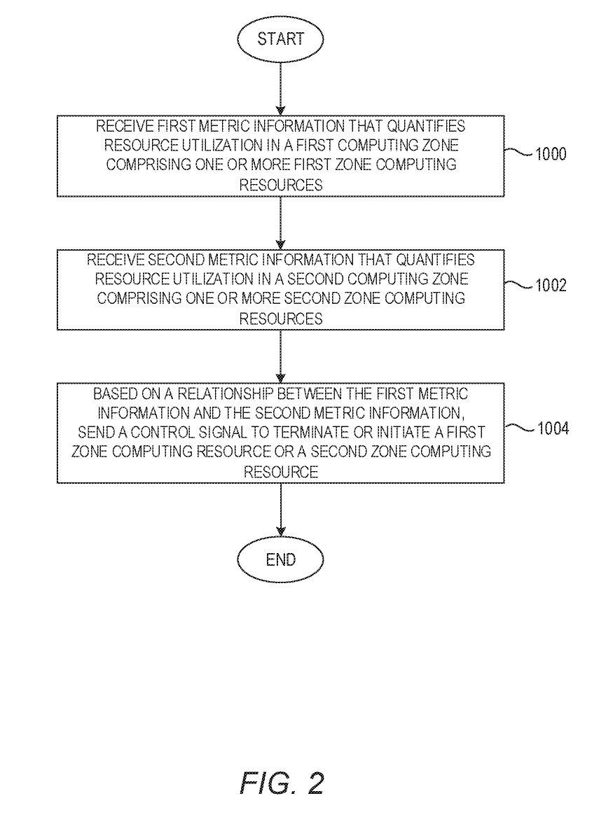

FIG. 2 is a flowchart of a method for implementing computing resource balancing among different computing zones according to one example. FIG. 2 will be discussed in conjunction with FIGS. 1A-1E. The computing device 26 receives the metric information 42 that quantifies resource utilization in the first computing zone 12A comprising the first zone computing resources 22A, 22B (FIG. 2, block 1000). The computing device 26 receives metric information 46 that quantifies resource utilization in the second computing zone 12B comprising the second zone computing resources 24A-24C (FIG. 2, block 1002). Based on a relationship between the first metric information 42 and the metric information 46, the computing device 26 sends the control signal 60 to terminate a computing resource 22 in the first computing zone 12A, and/or the control signal 62 to terminate a computing resource 24 in the second computing zone 12B (FIG. 2, block 1004).

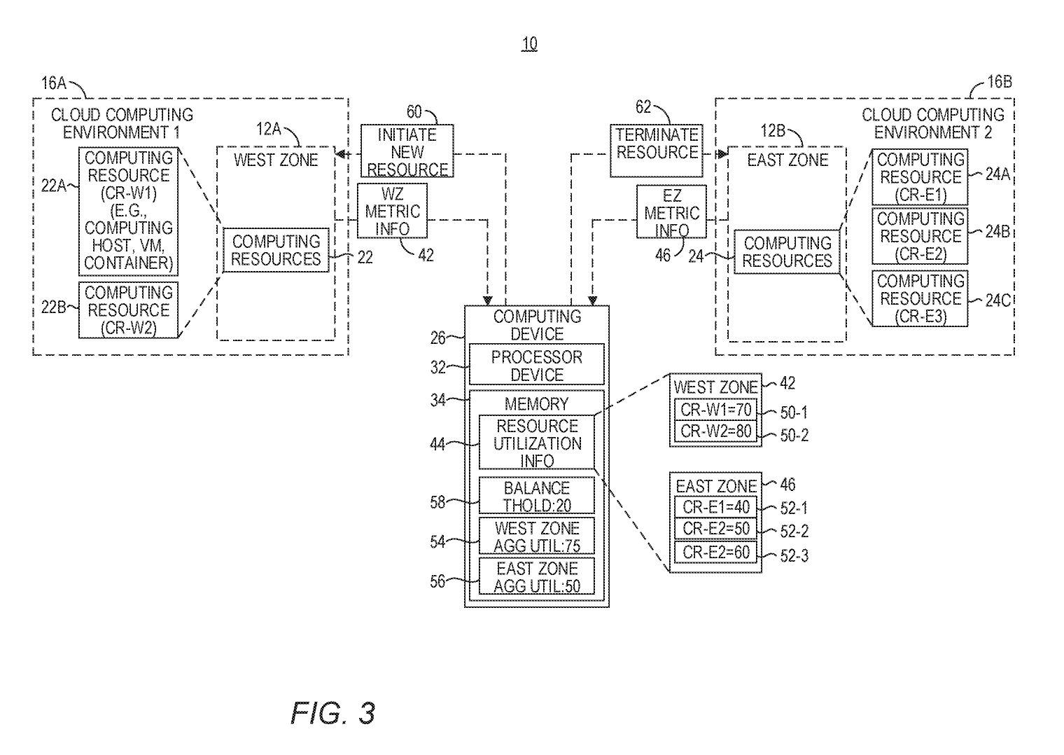

FIG. 3 is a simplified block diagram of the environment 10 illustrated in FIGS. 1A and 1B according to another example. The computing device 26 includes the memory 34 and the processor device 32 coupled to the memory 34. The computing device 26 receives the metric information 42 that quantifies the resource utilization in the first computing zone 12A comprising the computing resources 22A, 22B. The computing device 26 receives the metric information 46 that quantifies resource utilization in the second computing zone 12B comprising the computing resources 24A-24C. Based on a relationship between the metric information 42 and the metric information 46, the computing device 26 sends the control signal 60 to terminate a computing resource 22 in the first computing zone 12A, and/or the control signal 62 to terminate a computing resource 24 in the second computing zone 12B.

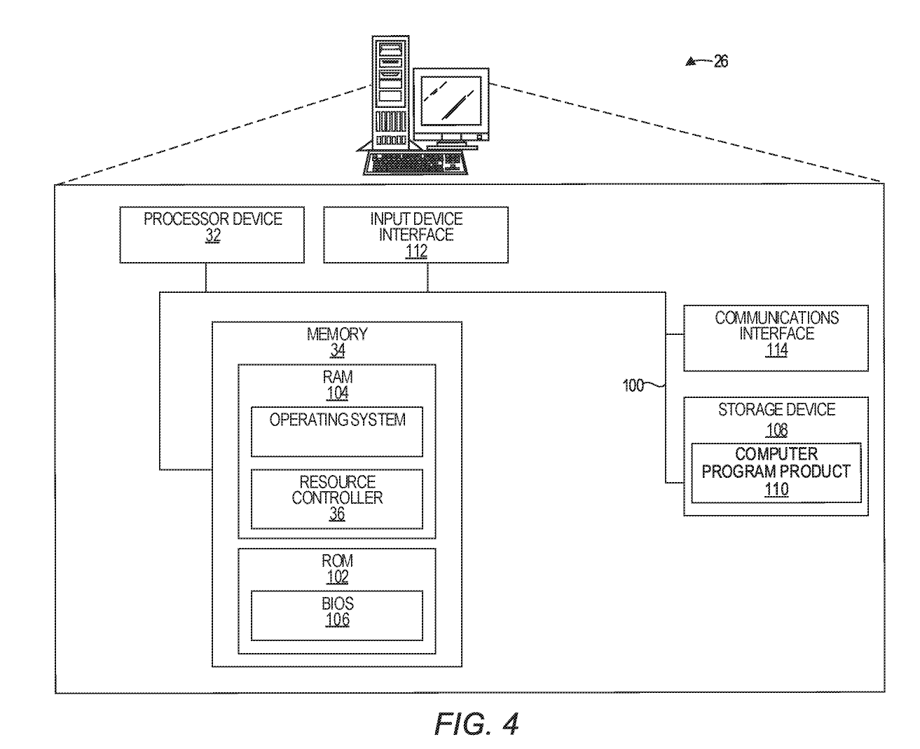

FIG. 4 is a block diagram of the computing device 26 suitable for implementing examples according to one example. The computing device 26 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 26 includes the processor device 32, the memory 34, and a system bus 100. The system bus 100 provides an interface for system components including, but not limited to, the memory 34 and the processor device 32. The processor device 32 can be any commercially available or proprietary processor.

The system bus 100 may be any of several types of bus structures that may further interconnect to a memory bus (with or without a memory controller), a peripheral bus, and/or a local bus using any of a variety of commercially available bus architectures. The memory 34 may include non-volatile memory 102 (e.g., read-only memory (ROM), erasable programmable read-only memory (EPROM), electrically erasable programmable read-only memory (EEPROM), etc.), and volatile memory 104 (e.g., random-access memory (RAM)). A basic input/output system (BIOS) 106 may be stored in the non-volatile memory 102 and can include the basic routines that help to transfer information between elements within the computing device 26. The volatile memory 104 may also include a high-speed RAM, such as static RAM, for caching data.

The computing device 26 may further include or be coupled to a non-transitory computer-readable storage medium such as a storage device 108, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 108 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 108 and in the volatile memory 104, including an operating system and one or more program modules, such as the resource controller 36, which may implement the functionality described herein in whole or in part.

All or a portion of the examples may be implemented as a computer program product 110 stored on a transitory or non-transitory computer-usable or computer-readable storage medium, such as the storage device 108, which includes complex programming instructions, such as complex computer-readable program code, to cause the processor device 32 to carry out the steps described herein. Thus, the computer-readable program code can comprise software instructions for implementing the functionality of the examples described herein when executed on the processor device 32. The processor device 32, in conjunction with the resource controller 36 in the volatile memory 104, may serve as a controller, or control system, for the computing device 26 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 32 through an input device interface 112 that is coupled to the system bus 100 but can be connected by other interfaces such as a parallel port, an Institute of Electrical and Electronic Engineers (IEEE) 1394 serial port, a Universal Serial Bus (USB) port, an IR interface, and the like.

The computing device 26 may also include a communications interface 114 suitable for communicating with the network 28 as appropriate or desired.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a computing device comprising a processor device, first metric information that quantifies resource utilization in a first computing zone comprising one or more first zone computing resources;
receiving second metric information that quantifies resource utilization in a second computing zone comprising one or more second zone computing resources; and
based on a relationship between the first metric information and the second metric information, sending a control signal to terminate or initiate a first zone computing resource or a second zone computing resource.

2. The method of claim 1 wherein the first computing zone comprises a first data center comprising a first plurality of computing hosts and the second computing zone comprises a second data center comprising a second plurality of computing hosts, the first data center being geographically separate from the second data center.

3. The method of claim 1 wherein the one or more first zone computing resources comprise one or more of computing hosts, virtual machines, and containers executing in the first computing zone.

4. The method of claim 1 wherein the first metric information comprises one or more of memory utilization information of each first zone computing resource, processor utilization information of each first zone computing resource, and network utilization information of each first zone computing resource.

5. The method of claim 1 further comprising:
determining the relationship between the first metric information and the second metric information by:
determining a first aggregate resource utilization associated with the first computing zone based on the first metric information;
determining a second aggregate resource utilization associated with the second computing zone based on the second metric information; and
determining that a difference between the first aggregate resource utilization and the second aggregate resource utilization exceeds a predetermined threshold.

6. The method of claim 5 wherein the predetermined threshold is in a range between about 10 and 40.

7. The method of claim 5 wherein the first metric information comprises a plurality of resource utilization values, each resource utilization value corresponding to a different first zone computing resource, and wherein determining the first aggregate resource utilization associated with the first computing zone comprises determining an average resource utilization value based on the plurality of resource utilization values and a total quantity of the different first zone computing resources.

8. The method of claim 5 further comprising:
subsequent to sending the control signal:
receiving, by the computing device, subsequent first metric information that quantifies resource utilization in the first computing zone;
receiving subsequent second metric information that quantifies resource utilization in the second computing zone;
determining a second relationship between the subsequent first metric information and the subsequent second metric information; and
based on the second relationship, maintaining a current number of first zone computing resources and second zone computing resources by not sending a control signal that terminates or initiates a first zone computing resource or a second zone computing resource.

9. The method of claim 8 wherein:
determining the second relationship between the subsequent first metric information and the subsequent second metric information by:
determining a subsequent first aggregate resource utilization associated with the first computing zone based on the subsequent first metric information;
determining a subsequent second aggregate resource utilization associated with the second computing zone based on the subsequent second metric information; and
determining that a difference between the subsequent first aggregate resource utilization and the subsequent second aggregate resource utilization is less than a predetermined threshold.

10. The method of claim 1 further comprising:
iteratively, over a period of time:
receiving the first metric information and the second metric information;
determining a current relationship between the first metric information and the second metric information; and
based on the current relationship, 1) sending a control signal to terminate or initiate a first zone computing resource or a second zone computing resource or 2) maintaining a current number of first zone computing resources and second zone computing resources by not sending a control signal that terminates or initiates a first zone computing resource or a second zone computing resource.

11. The method of claim 1 wherein sending the control signal comprises sending a message to a zone controller to terminate a first zone computing resource.

12. The method of claim 1 wherein sending the control signal comprises sending a message to a zone controller to initiate an additional first zone computing resource.

13. The method of claim 1 further comprising:
determining a first aggregate resource utilization associated with the first computing zone based on the first metric information;
determining a second aggregate resource utilization associated with the second computing zone based on the second metric information;
determining that one of the first aggregate resource utilization and the second aggregate resource utilization is outside of a desired threshold range; and
in response to determining that one of the first aggregate resource utilization and the second aggregate resource utilization is outside of a desired threshold range, determining the relationship between the first metric information and the second metric information, and sending the control signal to terminate or initiate the first zone computing resource or the second zone computing resource.

14. The method of claim 1 wherein the first computing zone comprises a first cloud computing environment operated by a first entity and configured to receive a control signal to terminate or initiate a first zone computing resource from a computing device outside of the first computing zone.

15. The method of claim 14 wherein the second computing zone comprises a second cloud computing environment operated by a second entity and configured to receive a control signal to terminate or initiate a second zone computing resource from a computing device outside of the second computing zone.

16. The method of claim 1 wherein the first computing zone is a first data center operating in a first time zone and the second computing zone is a second data center operating in a second time zone.

17. A computing device, comprising:
a memory;
a processor device coupled to the memory to:
receive first metric information that quantifies resource utilization in a first computing zone comprising one or more first zone computing resources;
receive second metric information that quantifies resource utilization in a second computing zone comprising one or more second zone computing resources; and
based on a relationship between the first metric information and the second metric information, send a control signal to terminate or initiate a first zone computing resource or a second zone computing resource.

18. The computing device of claim 17 wherein the processor device is further to:
determine the relationship between the first metric information and the second metric information by:
determining a first aggregate resource utilization associated with the first computing zone based on the first metric information;
determining a second aggregate resource utilization associated with the second computing zone based on the second metric information; and
determining that a difference between the first aggregate resource utilization and the second aggregate resource utilization exceeds a predetermined threshold.

19. A computer program product stored on a non-transitory computer-readable storage medium and including instructions to cause a processor device to:
receive first metric information that quantifies resource utilization in a first computing zone comprising one or more first zone computing resources;
receive second metric information that quantifies resource utilization in a second computing zone comprising one or more second zone computing resources; and
based on a relationship between the first metric information and the second metric information, send a control signal to terminate or initiate a first zone computing resource or a second zone computing resource.

20. The computer program product of claim 19 wherein the instructions further cause the processor device to:
determine the relationship between the first metric information and the second metric information by:
determining a first aggregate resource utilization associated with the first computing zone based on the first metric information;
determining a second aggregate resource utilization associated with the second computing zone based on the second metric information; and
determining that a difference between the first aggregate resource utilization and the second aggregate resource utilization exceeds a predetermined threshold.
